(19) United States
(12) Patent Application Publication
(10) Pub. No.: US 2021/0094051 A1
(43) Pub. Date: Apr. 1, 2021

(54) Sprinkler Head

(71) Applicant: SENJU SPRINKLER CO., LTD., Tokyo (JP)

(72) Inventor: Yasuaki Koiwa, Tokyo (JP)

(73) Assignee: SENJU SPRINKLER CO., LTD., Tokyo (JP)

(21) Appl. No.: 16/772,649

(22) PCT Filed: Aug. 9, 2018
(86) PCT No.: PCT/JP2018/029863

§ 371 Date: Jun. 12, 2020

(30) Foreign Application Priority Data
Dec. 20, 2017 (JP) 2017-243322

(51) Int. Cl. B05B 3/04; A62C 35/68

(52) U.S. Cl. CPC B05B 3/0486; A62C 35/68

(57) ABSTRACT

A sprinkler head includes a body having a nozzle connected to a water supply pipe, the nozzle being provided inside the body; a pair of arms extending from the body in a direction of water discharge from the nozzle, the arms having distal ends coupled to a columnar boss provided on a center axis of the nozzle, the boss having an internal thread carved on an inside; an impression screw being in mesh with the internal thread, the impression screw having a tip projecting toward the nozzle; a disc-shaped deflector provided at an end of the boss; and a plurality of slits provided in the deflector and each extending from an outer periphery of the deflector toward the center axis of the nozzle. The deflector further has a tapered slit tapered from a center of the deflector toward the outer periphery. The tapered slit is provided adjacent to a straight slit having a constant width.

### TECHNICAL FIELD

The present invention relates to fire-extinguishing sprinkler heads, particularly to a residential sprinkler head.

### BACKGROUND ART

Sprinkler systems are installed in buildings. Such a sprinkler system is automatically activated at the sensing of the heat of fire and sprinkles water to extinguish the fire. A sprinkler head includes a nozzle thereinside. The nozzle is connected to a pipe connected to a water supply source. In normal times, the nozzle is closed. If a fire occurs and the sprinkler head is activated with the heat, the nozzle is opened, whereby water stored in the pipe is discharged from the nozzle. The sprinkler head includes a deflector provided on an extension of the outlet of the nozzle. The deflector scatters water in all directions. When water collides with the deflector, the water is sprinkled over a predetermined range, whereby the fire is suppressed and extinguished.

Sprinkler systems are installed in commercial facilities, public facilities, residential dwellings, and so forth. There are standards for installation and construction of sprinkler systems. In America, National Fire Protection Association provides a set of standards NFPA 13 as a benchmark for design and installation of sprinkler systems for different buildings uses. The standards for residential sprinkler systems are coded as NFPA 13D and 13R. Underwriters Laboratories (UL LLC) provides another standard UL 1626 for residential sprinkler heads.

According to UL 1626, a residential sprinkler head must sprinkle water not only onto the floor but also onto the wall. Regarding water sprinkling onto the wall, the area of the wall to be wetted must be at a predetermined distance or shorter from the ceiling toward the floor. Hitherto known residential sprinkler heads are disclosed by U.S. Pat. Nos. 6,516,893 and 7,201,234.

### CITATION LIST

### Patent Literature

PTL 1: U.S. Pat. No. 6,516,893

PTL 2: U.S. Pat. No. 7,201,234

### SUMMARY OF INVENTION

### Technical Problem

Under the above circumstances, there is a trade-off between the amount of water sprinkling onto the floor and the area of wall wetting. An object of the present invention is to provide a sprinkler head that achieves both a satisfactory amount of water sprinkling onto the floor and a satisfactory area of wall wetting.

### Solution to Problem

To achieve the above object, the present invention provides the following sprinkler head.

A sprinkler head includes a body having a nozzle connected to a water supply pipe, the nozzle being provided inside the body; a pair of arms extending from the body in a direction of water discharge from the nozzle, the arms having distal ends coupled to a columnar boss provided on a center axis of the nozzle, the boss having an internal thread carved on an inside; an impression screw being in mesh with the internal thread, the impression screw having a tip projecting toward the nozzle; a disc-shaped deflector provided at an end of the boss; and a plurality of slits provided in the deflector and each extending from an outer periphery of the deflector toward the center axis of the nozzle. The deflector further has a tapered slit tapered from a center of the deflector toward the outer periphery. The tapered slit is provided adjacent to a straight slit having a constant width.

The above sprinkler head is a residential sprinkler head with a K factor of 3 to 5.8. The K factor is obtained from the flow rate and the discharge pressure of the nozzle. The deflector has the plurality of slits each extending from the outer periphery thereof toward the center axis of the nozzle. The deflector further has the tapered slit tapered from the center of the deflector toward the outer periphery. The tapered slit has an arc-shaped end on a side nearer to the center axis of the nozzle, and a width of the tapered slit at an end on the outer periphery of the deflector is smaller than a diameter of the arc shape. The tapered slit causes water that is discharged from the end nearer to the center axis of the nozzle to travel downward. Therefore, the amount of water sprinkling onto the floor is increased. On the other hand, water that is discharged from the end nearer to the outer periphery of the deflector travels farther toward the wall because the width of the slit that becomes smaller toward that end increases the flow velocity.

The tapered slit produces an advantageous effect of increasing the amount of water sprinkling onto the floor while suppressing the reduction in the flight range. The tapered slit may be provided adjacent to the straight slit having a constant width from the side nearer to the center axis of the nozzle to the side nearer to the outer periphery of the deflector, or adjacent to a plane in which the pair of arms extend. In the above configuration, the amount of water sprinkling onto the floor and the area of wall wetting can be controlled.

The tapered slit has an angle of 8° to 10°. If the angle is smaller than this, the above advantageous effects cannot be produced. Conversely, if the angle is too large, the force with which water is discharged from the end on the outer periphery of the deflector is reduced, reducing the flight range in the direction toward the wall.

In addition, depending on the shapes of the deflector, the boss provided on the deflector, and the impression screw screwed into the boss, the occurrence of turbulent flow can be prevented. More specifically, if the tip of the impression screw with which the water discharged from the nozzle first collides and the boundary between the impression screw and the boss are configured in such a manner as to suppress the occurrence of turbulent flow, the pattern of water sprinkling can be controlled easily.

The tip of the impression screw projects toward the nozzle and is pointed. Such a shape produces an advantageous effect of reducing the resistance on the water flow and evenly distributing the water colliding with the tip in all directions. The impression screw has an inclined surface extending from the tip thereof toward a side nearer to the boss, so that the water runs down along the inclined surface. An extension extended along the inclined surface is in proximity to or in contact with a curved surface at an outer peripheral end of the boss. Therefore, the water flows smoothly from the inclined surface and along the curved surface at the outer peripheral end of the boss. The flow of the water having passed the outer periphery of the boss and reached the flat surface of the deflector passes through the slits provided at the outer periphery of the deflector and is scattered toward the floor, otherwise the water having reached the outer periphery of the deflector is scattered toward the wall.

Here, the probability that the arms may hinder the flow of water is the lowest on a line perpendicularly intersecting the plane in which the pair of arms extend and passing through the center axis of the nozzle. Since no elements that hinder the flow of water are present on the line, the water can flow smoothly. Therefore, the water is discharged with a strong force and is scattered farther, providing a satisfactory amount of water that can wet the wall up to a position higher than specified. On the other hand, however, the amount of water sprinkling onto a near range immediately below the sprinkler head tends to be insufficient. To avoid such a situation, slits provided at corresponding positions are made longer than the other slits so that the water is guided toward the floor, whereby the amount of water sprinkling onto the near range can be increased. Thus, water can be sprinkled evenly onto the floor. Simultaneously, the wall can be wetted up to a desired height.

### Advantageous Effects of Invention

As described above, according to the present invention, a sprinkler head that achieves both a satisfactory amount of water sprinkling onto the floor and a satisfactory area of wall wetting can be provided. Furthermore, the occurrence of turbulent flow is prevented by suppressing the occurrence of turbulent flow at the tip of the impression screw and at the boss. Furthermore, the above sprinkler head can clear the water distribution test and the fire-extinguishing test specified by UL 1626 with the lowest flow rate possible.

### BRIEF DESCRIPTION OF DRAWINGS

FIG. 1 is an outside view of a sprinkler head according to the present invention.

FIG. 2 is a sectional view taken along line II-II illustrated in FIG. 1.

FIG. 3 is an enlarged view of a boss and relevant elements therearound illustrated in FIG. 2.

FIG. 4 is a plan view of a deflector.

FIG. 5 is a diagram illustrating a positional relationship between the sprinkler head and a water distribution test system.

FIG. 6 is a sectional view taken along line 6-6 illustrated in FIG. 1.

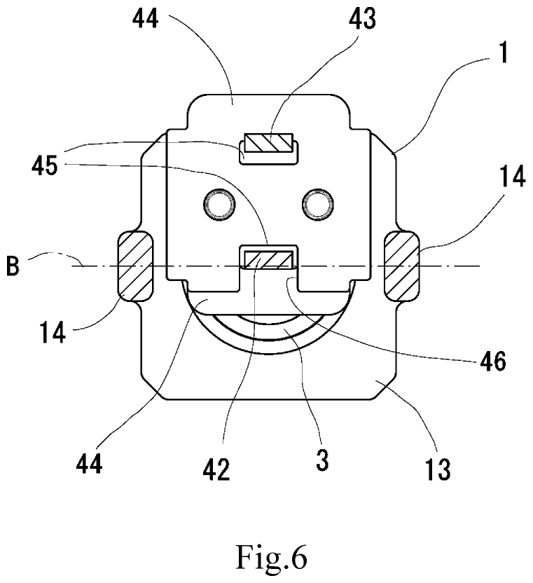

### DESCRIPTION OF EMBODIMENTS

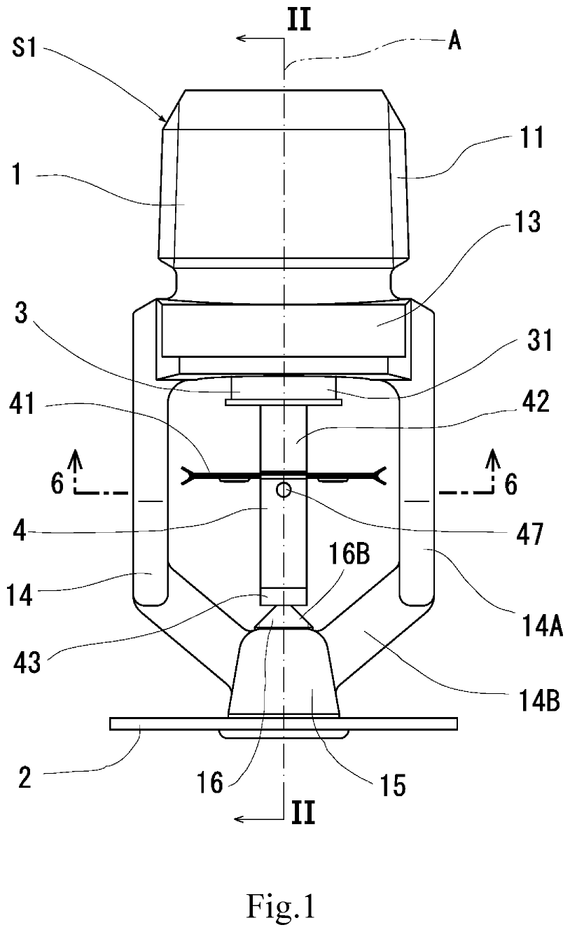

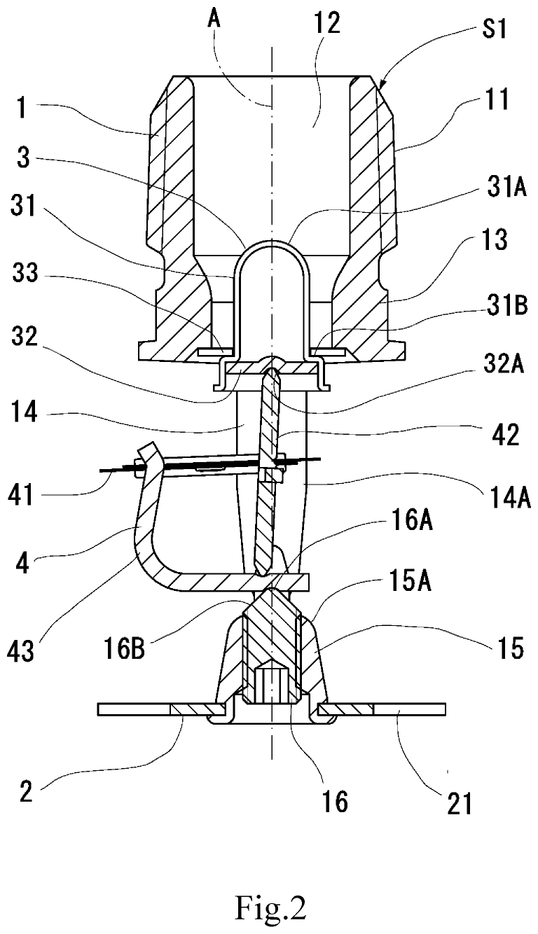

A sprinkler head S1 according to the present invention illustrated in FIGS. 1 and 2 includes a body 1, a deflector 2, a valve 3, and a heat-sensitive disassembling unit 4.

The body 1 has a hollow shape, with an external thread 11 carved on the outside thereof and a nozzle 12 formed on the inside thereof. The external thread 11 is provided for connection to a pipe provided in a ceiling space. The size of the nozzle 12 is defined within a range of a K factor of 3 to 5.8. The K factor is obtained from the flow rate and the discharge pressure of the nozzle 12. The K factor in the present embodiment is 4.9. The size of the external thread 11, which is connected to the pipe, is NPT 1/2 or R 1/2.

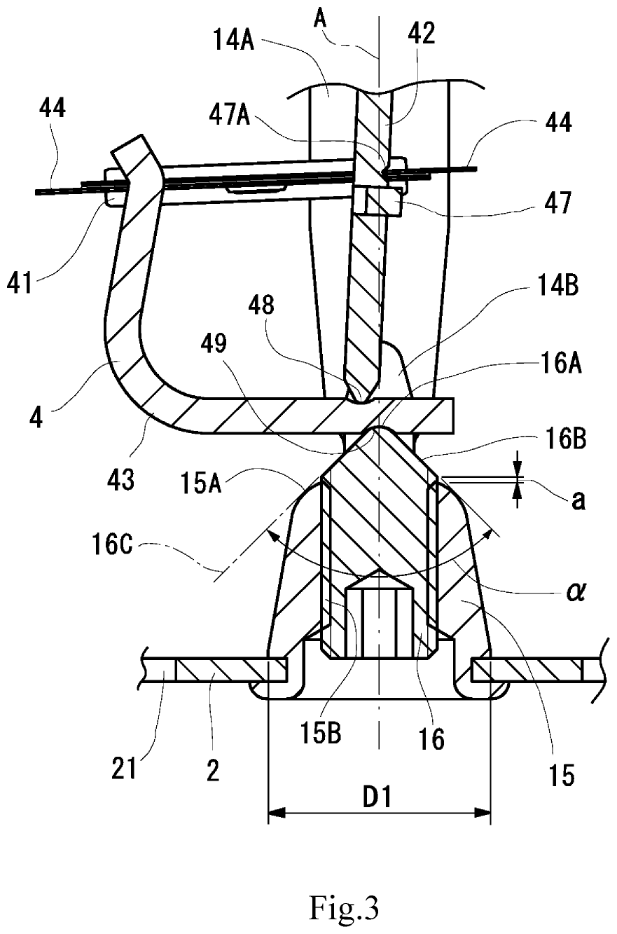

A substantially rectangular base 13 is provided near the outlet of the nozzle 12. A pair of arms 14 extend from the base 13 in a direction of water discharge from the nozzle 12. The arms 14 each include a linear portion 14A extending substantially parallel to a center axis A of the nozzle, and an intersecting portion 14B extending from an end of the linear portion 14A and coupled to a boss 15 provided on the center axis A of the nozzle 12. As illustrated in FIG. 3, the intersecting portion 14B is narrower than the linear portion 14A and has an elliptical sectional shape.

The boss 15 has a tapered round columnar shape. The deflector 2 is provided at an end of the boss 15. A diameter D1 of the boss 15 on a side where the boss 15 is in contact with the deflector 2 is 9 to 10 mm. The diameter of the boss 15 on a side nearer to the nozzle 12 is smaller than the diameter D1 on the side nearer to the deflector 2. An outer peripheral end 15A of the boss 15 on the side nearer to the nozzle 12 has a curved surface with a radius of curvature of 1 mm to 3 mm. In the present embodiment, the radius of curvature is 2 mm.

The boss 15 has an internal thread 15B carved on the inside thereof. An impression screw 16 is screwed into the boss 15. The impression screw 16 has a pointed tip 16A with an inclined surface 16B. The tip 16A faces toward the nozzle 12. The inclined surface 16B is at an angle α of preferably 80° to 100°. In the present embodiment, the angle α is 90°. The tip 16A has a spherical top with a spherical radius of preferably 2 mm or smaller. In the present embodiment, the spherical radius is 1 mm or smaller.

The impression screw 16 has a function of pressing the valve 3 toward the nozzle 12 with the heat-sensitive disassembling unit 4 in between. In FIG. 3, an extension 16C extended along the inclined surface 16B around the tip 16A of the impression screw 16 is in proximity to or in contact with the curved surface at the outer peripheral end 15A of the boss 15. Therefore, water running along the surface of the tip 16A and being about to pass the outer peripheral end 15A is not hindered from running along the outer peripheral end 15A, whereby the occurrence of turbulent flow is prevented. In the above configuration, an interval a between the inclined surface 16B of the impression screw 16 and an end face of the boss 15 on the side nearer to the nozzle 12 is set to 2 mm or smaller, more preferably 1 mm or smaller. If the interval is greater than the above, the probability of occurrence of turbulent flow increases.

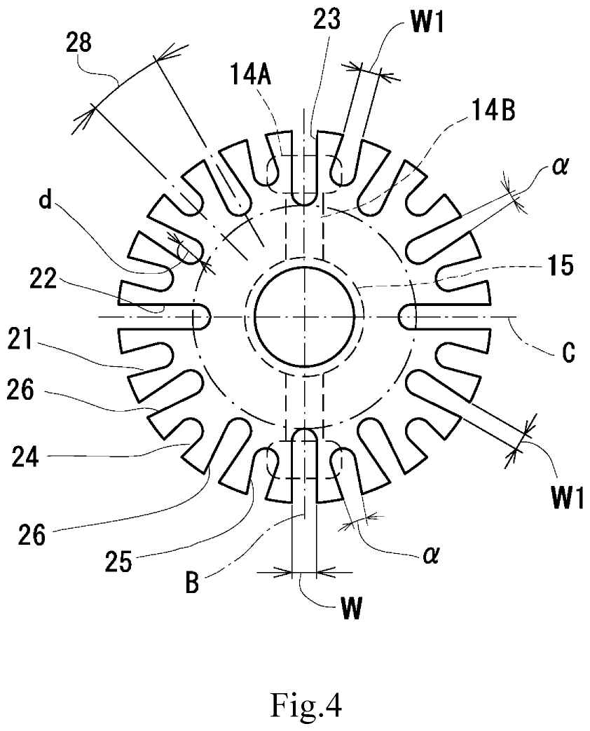

The deflector 2 illustrated in FIG. 4 has a disc shape with an outside diameter of 28 to 32 mm. In the present embodiment, the outside diameter is 30 mm. The deflector 2 has a plurality of slits at the peripheral edge thereof. The slits each extend from the peripheral edge toward the center of the deflector 2.

The arms 14 illustrated by broken lines in FIG. 4 are positioned on a line B. The line B represents a plane passing through the pair of arms 14. Slits 22 (third straight slits) are provided on a line C perpendicularly intersecting the line B and passing through the center axis A. The slits 22 are the longest among all the slits. Slits 21 are provided adjacent to each of the slits 22. The slits 21 and 22 are each a “straight slit” having a constant width: that is, the width on a side nearer to the center axis of the nozzle and the width on a side nearer to the outer periphery of the deflector are equal.

Slits 23 are provided on the line B on which the pair of arms 14 extend. Slits 24, which are the shortest, are provided at respective positions defined by rotating the line B by 45° about the center axis A. Tapered slits 25 are provided adjacent to each of the slits 23. Furthermore, tapered slits 26 are each provided adjacent to a corresponding one of the slits 24.

The total number of slits, specifically the slits 21 to 24 as straight slits and the tapered slits 25 and 26, is set within 16 to 28. In the present embodiment, the total number is set to 24. The slits 21 to 24 each have a width W of 1 to 2 mm. The deflector 2 has a symmetrical shape about the line B and about the line C.

The slits 21 to 24 each have an arc-shaped end on the side nearer to the center axis A of the nozzle, with a width that is constant from the arc-shaped end to the end on the outer periphery of the deflector. The diameter of the arc is equal to the width W of each of the slits 21 to 24. The width of each slit is smaller than the width of each intersecting portion 14B of the arm 14.

The tapered slits 25 and 26 each have an arc-shaped end on the side nearer to the center axis A of the nozzle. The arc has a diameter d of 1.5 to 2 mm. The diameter d of the arc is smaller than the width of the intersecting portion 14B of the arm 14. The tapered slits 25 and 26 each have a width W1 of 1 to 1.6 mm at an end on the outer periphery of the deflector 2, and a slit angle α of 8° to 10°. The diameter d of the arc is greater than the width W1 at the end on the outer periphery. The tapered slits 25 and 26 each have a drop-like shape with no irregularities, i.e. extending smoothly, between the arc portion and the tapered portion.

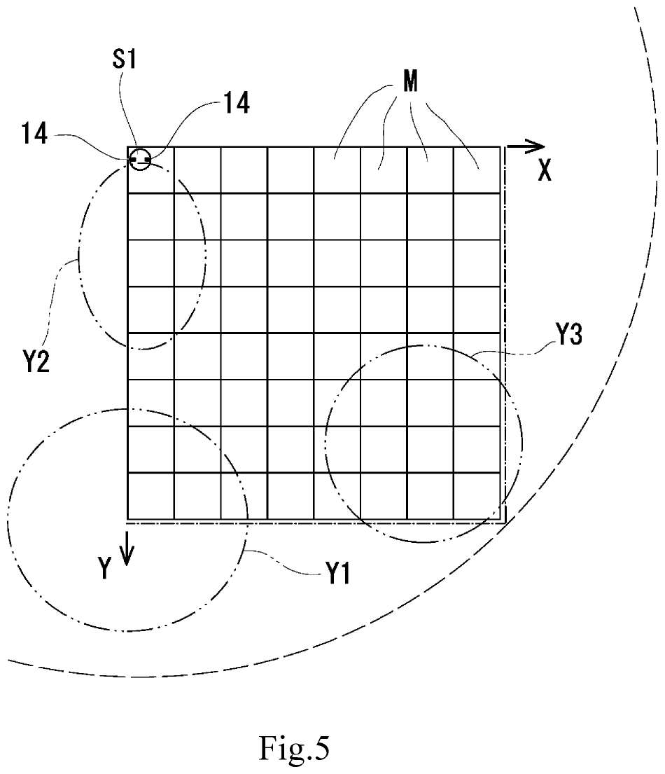

Referring to the positional relationship between the sprinkler head S1 and a water distribution test system illustrated in FIG. 5, the sprinkler head S1 is set at a position of the ceiling that corresponds to a corner of a matrix of water-collecting boxes M that are arrayed with no gaps. The one-dot chain line in the drawing represents a wall adjoining the water-collecting boxes M. In FIG. 5, the arms 14 are aligned in a direction of arrow X, and the slits 22 are aligned in a direction of arrow Y. According to UL 1626, a predetermined amount of water or more needs to be collected by each of the boxes M. This test system is capable of measuring the amount of water sprinkled over ¼ of the area to be protected by the sprinkler head S1. The pattern of water sprinkling is substantially circular, conforming to the shape of the deflector 2. Ideally, it is preferable that the water be sprinkled evenly over all the water-collecting boxes located within the ¼ of the circle represented by a broken line in FIG. 5.

However, the arms 14 hinder the flow of water discharged from the nozzle 12. Consequently, the flight range of water in the direction of arrow X is shorter than in the Y direction. Meanwhile, in the Y direction, the amount of water sprinkling tends to be greater in a zone Y1, which is farther from the sprinkler head S1, and smaller in a zone Y2, which is nearer to the sprinkler head S1. Nevertheless, if the length of the slits 22 is adjusted, the amount of water sprinkling over the zone Y1 can be reduced while the amount of water sprinkling over the zone Y2 is increased, so that the water can be sprinkled substantially evenly over all the water-sprinkling boxes. Thus, the amount of water sprinkling over the zones Y1 and Y2 can be controlled arbitrarily.

Furthermore, the tapered slits 25 provided adjacent to the arms 14 function to increase the amount of water sprinkling onto the floor in the direction of the arms 14 (the direction of arrow X in the drawing). Specifically, the amount of water sprinkling tends to be insufficient in the direction of the arms 14 because the arms 14 hinder the flow of water discharged from the nozzle 12. However, the tapered slits 25 function to compensate for the insufficiency in the amount of water sprinkling onto the floor and the wall. The slits 23 each provided between corresponding two of the tapered slits 25 are longer than the tapered slits 25.

The tapered slits 26 are each provided adjacent to a corresponding one of the slits 24. The slit 24 extends toward a zone Y3, which is the farthest from the sprinkler head S1, and has a reduced length, whereby the flight range of sprinkled water is increased to reach the wall. Therefore, the amount of water sprinkling onto the floor tends to be insufficient. Nevertheless, with the tapered slits 26, a satisfactory amount of water can be sprinkled over the zone Y3 of the floor, without reducing the flight range. The slits 24 are shorter than the tapered slits 26.

In normal times, the valve 3 covers the outlet of the nozzle 12. The valve 3 includes a valve cap 31, a disc 32, and a disc spring 33. The valve cap 31 has a cylindrical shape with one end thereof forming a spherical bottom portion 31A. The other end of the valve cap 31 has an increased diameter, forming a step 31B.

The disc 32, which is a circular plate, is placed on the inner peripheral side of the step 31B. The disc 32 has a recess 32A in the center thereof. The recess 32A is engaged with one end of a bar 42 included in the heat-sensitive disassembling unit 3.

The disc spring 33 is anchored on the outer peripheral side of the step 31B by inserting the valve cap 31 into the disc spring 33 from the bottom portion 31A. The surface of the disc spring 33 is coated with fluorocarbon resin. The outer peripheral edge of the disc spring 33 is positioned at the outlet end of the nozzle 12. Screwing the impression screw 16 into the boss 15 along the internal thread 15B causes the heat-sensitive disassembling unit 4 to press the disc spring 33, whereby the disc spring 33 is squashed while undergoing elastic deformation. In this process, the fluorocarbon resin serves as a sealing material and thus seals the nozzle 12.

The heat-sensitive disassembling unit 4 includes a link 41, the bar 42, and a lever 43. The link 41 is a heat-sensitive body activated with the heat of fire and includes two thin metal plates 44 that are joined to each other with a low-melting-point alloy. The low-melting-point alloy used here has a melting point within a range of 60 to 200° C. In general, a low-melting-point alloy having a melting point of 72° C. or 96° C. is used.

The two metal plates 44 each have a substantially square shape with a hole 45 at one end thereof and a rectangular-U-shaped cut 46 at the other end thereof. The two metal plates 44 are joined to each other with the low-melting-point alloy such that the end of each metal plate 44 where the cut 46 is provided is laid on the other metal plate 44. Specifically, the hole 45 of one of the metal plates 44 and the cut 46 of the other metal plate 44 are made to coincide with each other. After the above joining, the bar 42 and the lever 43 are inserted into the two holes 45 of the link 41, respectively.

The bar 42 has a strip-like shape with one end being engaged with the disc 32 of the valve 3 at the outlet of the nozzle 12, and the other end being engaged with an end of the lever 43. As described above, the bar 42 extends through the hole 45 of the link 41. The bar 42 has a projection 47 in a middle part thereof. The link 41 is anchored in a groove 47A provided near the projection 47.

The lever 43 is a long narrow plate that is bent in a substantially L shape. As described above, the one end of the lever 43 extends through the hole 45 of the link 41. The other end of the lever 43 is engaged with the bar 42. The lever 43 has a groove 48 with which an end of the bar 42 is engaged.

The lever 43 has a recess 49 on a side thereof opposite the side having the groove 48. The recess 49 is positioned nearer to the other end of the lever 43 than the groove 48. The impression screw 16 is in contact with the recess 49. When the tip of the impression screw 16 is pressed into the recess 49 of the lever 43, a force acts on the lever 43 to rotate the lever 43 about the groove 48, in which the bar 42 is anchored. However, since the one end of the lever 43 extends through the hole 45 of the link 41, the lever 43 is prevented from rotating. Hence, the link 41, the bar 42, and the lever 43 forming the heat-sensitive disassembling unit 4 are kept engaged with one another. Furthermore, the impression screw 16 keeps pressing the valve 3 toward the nozzle 12 with the heat-sensitive disassembling unit 4 in between.

In case of fire, when the low-melting-point alloy of the link 41 melts, the lever 43 rotates, whereby one of the metal plates 44 is stripped off the other metal plate 44. Consequently, the engagements in the heat-sensitive disassembling unit 4 are disabled. That is, the link 41, the bar 42, and the lever 43 are disengaged from one another, and the valve 3 that has been supported by the bar 42 drops off the nozzle 12, whereby the nozzle 12 is opened.

The embodiment of the present invention is as described above. Now, other configurations and effects thereof will be described.

While the above embodiment concerns a case where the part of the lever 43 that is engaged with the impression screw 16 is shaped as the recess 49, the part is not limited thereto and may be shaped as a projection. In that case, the tip of the impression screw 16 may be modified to be shaped as a recess or a groove conforming to the shape of the projection.

The present invention is also applicable to a sprinkler head including a glass bulb in replacement of the heat-sensitive disassembling unit 4. In that case, the tip of the impression screw 16 may be shaped as a recess that can receive the glass bulb.

All the slits 21 to 26 that are adjacent to one another on the outer periphery of the deflector 2 may be arranged at a constant pitch 28. The slits 21 to 26 may each extend on a virtual line extending from the outer periphery of the deflector 2 and passing through the center axis A of the nozzle. The slits 21 to 24 may all have the same width. The slits 25 and 26 may form the same angle α. Alternatively, the angle α may vary within a range of 8 to 10°.

The slits 22, which are the longest, are positioned nearest to the line C. While the slits 22 according to the above embodiment are provided on the line C, the slits 22 may alternatively be provided adjacent to the line C. In that case as well, the same advantageous effects can be produced.

### REFERENCE SIGNS LIST

S1 sprinkler head

1 body

2 deflector

3 valve

4 heat-sensitive disassembling unit

12 nozzle

14 arm

15 boss

15A outer peripheral end of boss

16 impression screw

16B inclined surface

21, 23, 24 slit

22 slit (first slit)

25, 26 tapered slit

31 valve cap

32 disc

33 disc spring

41 link

42 bar

43 lever

1. A sprinkler head comprising:
a body having a nozzle connected to a water supply pipe, the nozzle being provided inside the body;
a pair of arms extending from the body in a direction of water discharge from the nozzle, the pair of arms having distal ends coupled to a columnar boss provided on a center axis of the nozzle;
an impression screw being in mesh with an internal thread carved on an inside of the boss, the impression screw having a tip projecting toward the nozzle;
a disc-shaped deflector provided at an end of the boss; and
a plurality of slits provided in the deflector and each extending from an outer periphery of the deflector toward the center axis of the nozzle,
wherein the deflector further has a tapered slit tapered from a center of the deflector toward the outer periphery and a third straight slit having a constant width,
wherein the third straight slit is provided at a position nearest to a line perpendicularly intersecting a plane in which the pair of arms extend and passing through the center axis of the nozzle, and is the longest of all the slits.

2. The sprinkler head according to claim 1,
wherein the deflector further has a first straight slit and a second straight slit having a constant width,
wherein the tapered slit is provided adjacent to the first straight slit or second straight slit.

3. The sprinkler head according to claim 1,
wherein the tapered slit is provided adjacent to a plane in which the pair of arms extend.

4. The sprinkler head according to claim 2,
wherein the first straight slit is provided on a plane in which the pair of arms extend, and
wherein the tapered slit is provided adjacent to the first straight slit.

5. The sprinkler head according to claim 4,
wherein the first straight slit is longer than the adjacent tapered slit.

6. The sprinkler head according to claim 2,
wherein a second straight slit is provided at a position defined by rotating a plane in which the pair of arms extend about the center axis of the nozzle by 45°,
the tapered slit being provided adjacent to the second straight slit.

7. The sprinkler head according to claim 6,
wherein the second straight slit is shorter than the adjacent tapered slit.

8. The sprinkler head according to claim 1,
wherein the tapered slit has an arc-shaped end on a side nearer to the center axis of the nozzle, and
wherein a width of the tapered slit at an end on the outer periphery of the deflector is smaller than a diameter of the arc-shaped end.

9. The sprinkler head according to claim 1,
wherein the tapered slit has an angle of 8° to 10°.

10. The sprinkler head according to claim 8,
wherein the diameter of the arc-shaped end is smaller than a width of each of the arms.

11. The sprinkler head according to claim 1,
wherein the boss has a curved surface at an outer peripheral end on a side nearer to the nozzle, and
wherein an extension extended along a tip of the impression screw is in proximity to or in contact with the curved surface.

12. The sprinkler head according to claim 1,
wherein the tip of the impression screw has an inclined surface at an angle of 80° to 100°.

13. The sprinkler head according to claim 12,
wherein the tip of the impression screw is pointed with a curved top defined by a radius of curvature of 2 mm or smaller.

14. The sprinkler head according to claim 1,
wherein an outer peripheral end of the boss on a side nearer to the nozzle has a curved surface.

15. The sprinkler head according to claim 14,
wherein the outer peripheral end of the boss on the side nearer to the nozzle has a radius of curvature of 1 mm to 3 mm.

16. The sprinkler head according to claim 1,
wherein a K factor obtained from a flow rate and a discharge pressure of the nozzle is 3 to 5.8.

17. (canceled)
